(19) United States
(12) Patent Application Publication
(10) Pub. No.: US 2018/0260875 A1
(43) Pub. Date: Sep. 13, 2018

(54) METHOD AND SYSTEM FOR PROVIDING ONE OR MORE PURCHASE RECOMMENDATIONS TO A USER

(71) Applicant: Wipro Limited, Bangalore (IN)

(72) Inventors: Venkata Subramanian Jayaraman, Chennai (IN); Sumithra Sundaresan, Chennai (IN)

(21) Appl. No.: 15/463,666

(22) Filed: Mar. 20, 2017

(30) Foreign Application Priority Data
Mar. 8, 2017 (IN) 201741008128

(51) Int. Cl. G06Q 30/06

(52) U.S. Cl. CPC G06Q 30/0631

(57) ABSTRACT

The present disclosure relates to field of retail environment. Accordingly, disclosed herein is a method and system for providing one or more purchase recommendations to a user. Purchase details corresponding to previous purchases by the user and user information are collected. Further, a plurality of optimal purchase parameters is determined by analyzing the purchase details based on the user information. Finally, one or more purchase recommendations are provided to the user based on the plurality of optimal purchase parameters. In an embodiment, the present method facilitates the user to identify a retail store that offers optimal savings on the purchase of a product of interest to the user. Also, the present method helps retailers to analyze purchase pattern of the user for predicting and determining appropriate products to be sold to the user on future purchases.

This application claims the benefit of Indian Patent Application Serial No. 201741008128, filed Mar. 8, 2017, which is hereby incorporated by reference in its entirety.

### FIELD

The present subject matter is related, in general to retail environment, and more particularly, but not exclusively to a method and a system for providing one or more purchase recommendations to a user.

### BACKGROUND

Presently, retail environment is stepping away from paper receipts and slowly moving towards a digital custom. Today, in most retail places, digital receipts are being given to customers instead of the paper receipts. Though the digital receipts are useful, most often, the digital receipts are associated with certain limitations. For example, it is difficult for the customers to search a digital receipt by name of a product or its price, among numerous digital receipts available with the customers. Hence, the customers must remember an exact date of purchase of the products if the customers want to track the digital receipts.

Further, since there are no sorting techniques available for classifying the digital receipts, analysis of expenditure of the customers based on purchase pattern of the customers during different time frames (weekly, monthly, yearly, and the like) has not been efficient and accurate. Due to inefficient and inaccurate analysis, there has been a lack of information on deals and comparisons available for individual customers. Consequently, even retailers or business vendors are finding it difficult to predict appropriate products to be sold to the customers.

### SUMMARY

Disclosed herein is a method of providing one or more purchase recommendations to a user. The method includes extracting, by a purchase prediction system, purchase details corresponding to purchase of one or more products by the user from one or more digital receipts. Further, the method includes collecting user information from one or more data sources associated with the user. Upon collecting the user information, a plurality of optimal purchase parameters for the user are determined by analyzing the purchase details based on the user information. The plurality of optimal purchase parameters includes age of the user, location details of the user and current trends in one or more retail stores. Finally, the method includes providing one or more purchase recommendations to the user based on the plurality of optimal purchase parameters.

Further, the present disclosure discloses a purchase prediction system for providing one or more purchase recommendations to a user. The purchase prediction system includes a processor and a memory. The memory may be communicatively coupled to the processor and stores processor-executable instructions, which, on execution, causes the processor to extract purchase details corresponding to purchase of one or more products by the user from one or more digital receipts. Further, the processor collects user information from one or more data sources associated with the user. Upon collecting the user information, the processor determines a plurality of optimal purchase parameters for the user by analyzing the purchase details based on the user information. The plurality of optimal purchase parameters includes age of the user, location details of the user and current trends in one or more retail stores. Finally, the processor provides one or more purchase recommendations to the user based on the plurality of optimal purchase parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment of providing one or more purchase recommendations to user in accordance with some embodiments of the present disclosure;

FIG. 2 shows a detailed block diagram illustrating a purchase prediction system for providing one or more purchase recommendations to the user in accordance with some embodiments of the present disclosure;

FIG. 3A and FIG. 3B represent exemplary outcomes of an analysis of purchase pattern of the user in accordance with an exemplary embodiment of the present disclosure;

FIG. 4 shows a flowchart illustrating a method of providing one or more purchase recommendation to the user in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, “includes”, “including” or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a purchase prediction system for providing one or more purchase recommendations to a user. Initially, the purchase prediction system receives and stores a digital receipt corresponding to purchase of one or more products by the user. Then, user information related to the user is collected from one or more data sources associated with the user. Later, the purchase prediction system analyzes the purchase details based on the user information to determine plurality of optimal purchase parameters such as, age of the user, location details of the user and current trends across one or more retails stores. Finally, the purchase prediction system provides the one or more purchase recommendations using the plurality of optimal purchase parameters.

In an embodiment, the method and the purchase prediction system disclosed in the present disclosure provide a means for analyzing and segregating the purchase details on the digital receipts by applying appropriate intelligence techniques on the purchase details. Due to segregation of the digital receipts, the user may conveniently search for and identify a required digital receipt among a good number of digital receipts.

In an embodiment, the method and the purchase prediction system of the present disclosure also help the retailers to effectively predict the expenditure of the users, spending pattern of the users and savings associated with the users, to predict one or more future purchases by the users. Based on this prediction, the retailers may notify the users about the release and/or availability of a product of utmost interest/relevance to the user. In an implementation, based on the analysis provided by the purchase prediction system, the users may determine an appropriate retail store to purchase a product, such that the retail store offers a maximum savings on the purchase of the product.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

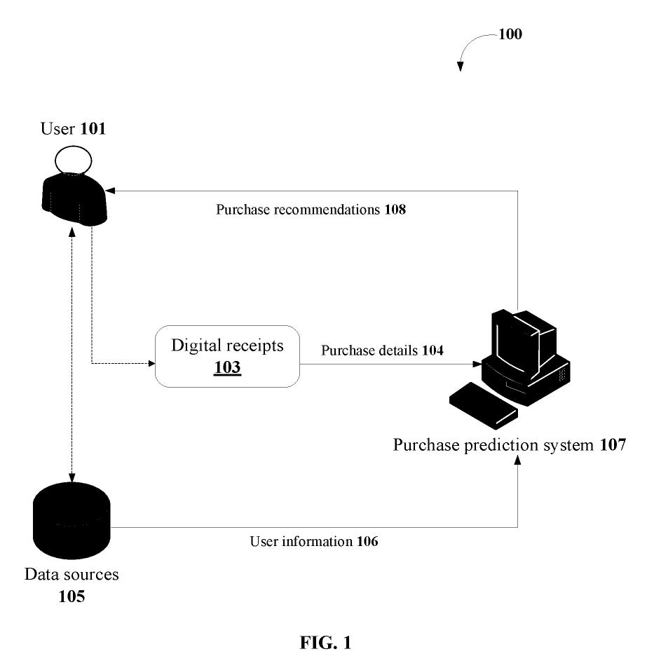

FIG. 1 shows an exemplary environment of providing one or more purchase recommendations to a user, in accordance with some embodiments of the present disclosure.

Accordingly, the environment 100 includes a user 101, one or more data sources 105 associated with the user 101 and a purchase prediction system 107. The user 101 may be a customer of one or more retail stores (not indicated in FIG. 1), who purchases one or more products from the one or more retail stores. As an example, one of the one or more retail stores may be a clothing store, in which the user 101 may purchase one or more clothing suits (products). Alternatively, the user 101 may be one or more retailers. In an embodiment, upon successful purchase of the one or more products by the user 101, the one or more retail stores may issue a purchase receipt to the user 101, in accordance with the purchased product.

In some embodiments, the purchase receipt may be in the form of a slip or a hardcopy of receipt. In other embodiments, the purchase receipt may be a digitized receipt, which is in the form of e-mails, Portable Document Formats (PDFs) or in any other printable format. In an implementation of the present disclosure, the user 101 may scan and store a scanned copy of the purchase receipt, thereby digitizing each purchase receipt received by the one or more retail stores, which are collectively indicated as digital receipts 103 in FIG. 1.

In an embodiment, the one or more data sources 105 are associated with the user 101 and store various information related to the user 101. As an example, the one or more data sources 105 may include, without limiting to, a customer database system configured in the one or more retail stores and social media profiles of the user 101. The customer database system located at the one or more retail stores may save various information such as, user information 106, details of all transactions performed by the user 101, number of visits and frequency of visits by the user 101 into one or more retail stores and loyalty and/or reward points associated with the user 101.

In an embodiment, the purchase prediction system 107 may extract purchase details 104 corresponding to purchase of the one or more products by the user 101 from the one or more digital receipts 103. As an example, the purchase details 104 extracted from the one or more digital receipts 103 may include, without limiting to, name of the user 101, name of the one or more products purchased by the user 101, purchase value or price of the one or more products and details of the one or more retail stores including the one or more products purchased by the user 101. Further, the purchase prediction system 107 may collect the purchase details 104 from the one or more digital receipts 103. As an example, the purchase details 104 may include, without limiting to, name of the user 101, age of the user 101, location details of the user 101, details of one or more previous purchases by the user 101, number of visits by the user 101 to the one or more retail stores and weekly average values of the number of visits and yearly average values of the number of visits.

Upon extracting the purchase details 104 and collecting the user information 106, the purchase prediction system 107 may determine a plurality of optimal purchase parameters for the user 101 by analyzing the purchase details 104 based on the user information 106. As an example, the plurality of optimal purchase parameters may include, without limiting to, age of the user 101, location details of the user 101 and current trends in one or more retail stores. Further, based on the plurality of optimal purchase parameters, the purchase prediction system 107 may provide one or more purchase recommendations 108 to the user 101. As an example, the one or more purchase recommendations 108 may include details of one or more retail stores for purchasing the one or more products of interest to the user 101, such that the one or more retail stores offer and/or sell the one or more products at a higher rate of savings.

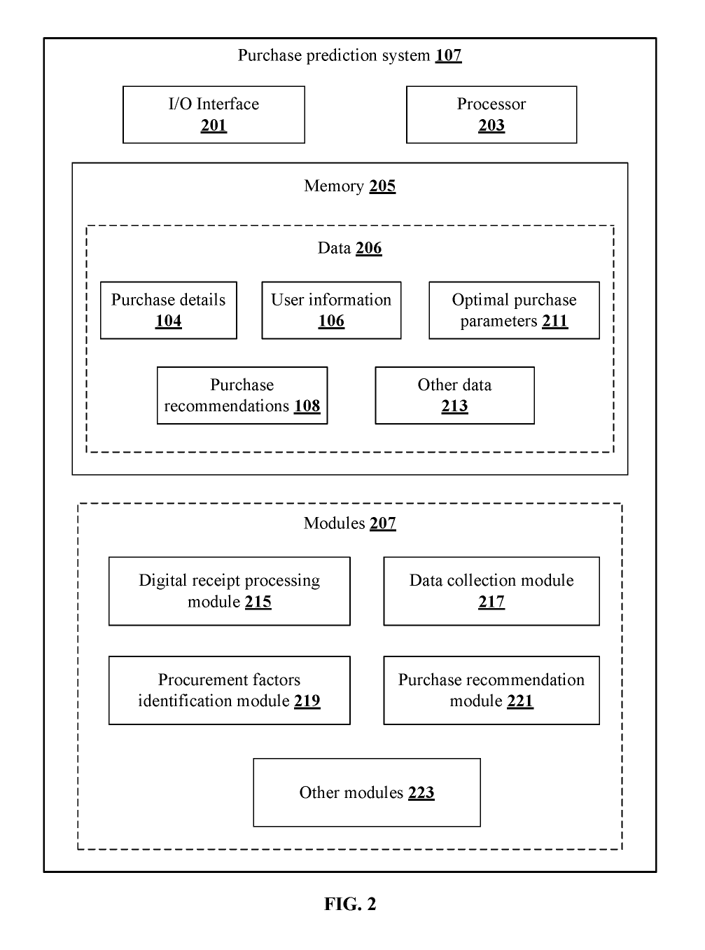

FIG. 2 shows a detailed block diagram illustrating the purchase prediction system 107 for providing one or more purchase recommendations 108 to the user 101 in accordance with some embodiments of the present disclosure.

The purchase prediction system 107 may include an I/O interface 201, a processor 203 and a memory 205. The I/O interface 201 may communicate with the one or more data sources 105 to collect the user information 106. The memory 205 may be communicatively coupled to the processor 203. The processor 203 may be configured to perform one or more functions of the purchase prediction system 107 for providing one or more purchase recommendations 108 to the user 101. In one implementation, the purchase prediction system 107 may include data 206 and modules 207, which are used for performing various operations in accordance with the embodiments of the present disclosure. In an embodiment, the data 206 may be stored within the memory 205 and may include, without limiting to, the purchase details 104, the user information 106, plurality of optimal purchase parameters 211, the one or more purchase recommendations 108 and other data 213.

In some embodiments, the data 206 may be stored within the memory 205 in the form of various data structures. Additionally, the data 206 may be organized using data models, such as relational or hierarchical data models. The other data 213 may store data, including temporary data and temporary files, generated by modules 207 while providing the one or more purchase recommendations 108 to the user 101.

In some embodiment, the purchase details 104 are extracted from the one or more digital receipts 103. As an example, the one or more purchase details 104 may include, without limiting to, name of the user 101, name of the one or more products purchased by the user 101, purchase value of the one or more products and details of the one or more retail stores including the one or more products purchased by the user 101. In an embodiment, the purchase details 104 may be directly obtained from a POS device, which was used for accomplishing payment to the purchase of the one or more products at the one or more retail stores. As an example, the purchase details 104 obtained from the POS device may include, without limiting to, time of purchase, a unique identifier (ID) associated with the one or more digital receipt, a list of the one or more products that were purchased at the one or more retail stores, the prices of the products and the discount provided on the products.

In an embodiment, the user information 106 includes all the information corresponding to the user 101. As an example, the user information 106 may be collected from the one or more data sources 105 associated with the user 101 and may include, without limiting to, name of the user 101, age of the user 101, location details of the user 101, details of one or more previous purchases by the user 101, number of visits by the user 101 to the one or more retail stores and weekly average values of the number of visits and yearly average values of the number of visits. Additionally, the user information 106 may also include information about interests and day-to-day routine of the user 101, which may be processed and analyzed to enhance the precision of the one or more purchase recommendations 108. In an embodiment, the user information 106 may be updated at regular intervals to consider and analyze recent purchase trend of the user 101, thereby improving the accuracy of the one or more purchase recommendations 108.

In an embodiment, the plurality of optimal purchase parameters 211 is determined by analyzing the purchase details 104 based on the user information 106. As an example, the plurality of optimal purchase parameters 211 may include, without limiting to, age of the user 101, location details of the user 101 and current trends in one or more retail stores. Further, the plurality of the optimal purchase parameters 211 is used for providing the one or more purchase recommendations 108 to the user 101.

In an embodiment, the one or more purchase recommendations 108 are provided to the user 101 based on at least one of the plurality of the optimal purchase parameters 211. The one or more purchase recommendations 108 provided by the purchase prediction system 107 may be used by the user 101 to identify the one or more retail stores that offer to sell the one or more products at a higher rate of savings (i.e. at a higher discount rate). Later, the user 101 may select one among the one or more identified retail stores for purchasing the one or more products of interest, thereby the user 101 may increase the savings from the purchase. Alternatively, the retailers of the one or more retail stores may use the one or more purchase recommendations 108 to analyze the interests and purchase trend of the user 101, thereby predicting most appropriate products to be sold to the user 101, at an appropriate rate of savings/discount.

In some embodiment, the data 206 may be processed by one or more modules 207 in the purchase prediction system 107. In one implementation, the one or more modules 207 may be stored as a part of the processor 203. In another implementation, the one or more modules 207 may be communicatively coupled to the processor 203 for performing one or more functions of the purchase prediction system 107. The modules 207 may include, without limiting to, a digital receipt processing module 215, a data collection module 217, a procurement factors identification module 219, a purchase recommendation module 221 and other modules 223.

As used herein, the term ‘module’ may refer to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 223 may be used to perform various miscellaneous functionalities of the purchase prediction system 107. It will be appreciated that such modules 207 may be represented as a single module or a combination of different modules.

In an implementation, the interfaces that establish interconnectivity among the modules 207 may include, without limiting to, Remote Procedure Call (RPC), Application Program Interface (API), Hypertext Transfer Protocol (HTTP) or Open Database Connectivity (ODBC) calls. Further the modules 207 may access the data 206 using various interface including, without limiting to, RPC, API, Sockets, or any other access mechanism.

In an embodiment, the digital receipt processing module 215 may be responsible for processing the one or more digital receipts 103 for extracting the purchase details 104 from the one or more digital receipts 103. The digital receipt processing module 215 may receive the one or more digital receipts 103 from the POS associated with the one or more retail stores to extract all the purchase details 104 related to the one or more products and the user 101. In an embodiment, the digital receipt processing module 215 may access the one or more digital receipts 103 that are manually scanned by the user 101 and uploaded on to the purchase prediction system 107 via one or more user 101 devices associated with the user 101. Further, the digital receipt processing module 215 may be responsible for identifying and eliminating one or more redundant information and false data from the purchase details 104 before further processing. As an example, a digital receipt which does not indicate the name of the user 101 may be eliminated before it is considered for providing the one or more purchase recommendations 108.

Further, the digital receipt processing module 215 may perform segregation of the purchase details 104 to identify what data is needed and what data is not required for providing the one or more purchase recommendations 108 to the user 101. Accordingly, the unwanted data such as, the data indicating wrong age of the user 101, duplicate entries of the same data and missing entries in the data are eliminated from the purchase details 104 during the segregation process.

In an embodiment, the data collection module 217 may be responsible for collecting the user information 106 from the one or more data sources 105 associated with the user 101. The data collection module 217 may collect the user information 106 in various formats such as, manual inputs from the user 101, automatically retrieved information from the POS and data retrieved from the customer database system located at the one or more retail stores. In an embodiment, the data collection module 217 may include a display unit, using which the user 101 may input various details such as a username, account number/credit card number, security passwords and the like, which are necessary for completing the transaction during the purchase.

In an embodiment, the procurement factors identification module 219 is responsible for identifying the one or more procurement factors based on at least one of the plurality of optimal purchase parameters 211. The procurement factors identification module 219 may identify the one or more procurement factors based on at least one of significance of the purchase to the user 101 or the frequency of the purchase by the user 101. In an embodiment, the one or more procurement factors is identified based on the significance of purchase to the user 101 if the age of the user 101 is higher than a predetermined threshold value. Alternatively, the one or more procurement factors is identified based on the frequency of purchase by the user 101 if the age of the user 101 is less than or equal to the predetermined threshold value. As an example, the predetermined threshold value of age may be 40 years.

In an embodiment, the purchase recommendation module 221 may be responsible for providing the one or more purchase recommendations 108 to the user 101. The one or more purchase recommendations 108 include details of one or more retail stores for purchasing the one or more products in an optimal savings rate. In an embodiment, the optimal savings rate may be a highest discount rate offered at the one or more retail stores on purchase of the one or more products. The one or more purchase recommendations 108 are provided based on at least one of the plurality of optimal purchase parameters 211. As an example, the at least one of the plurality of optimal purchase parameters 211 may be age of the user 101. In one scenario, the purchase recommendation module 221 may generate different set of the purchase recommendations 108 based on the age of the user 101. Suppose, if the age of the user 101 is 60 years, then the purchase recommendation module 221 may provide one or more purchase recommendations 108 relating to the health of the user 101. On the other hand, if the user 101 is a teenager aged about 25 years, the purchase recommendation module 221 may provide one or more purchase recommendations 108 related to sports equipment or clothing.

In some embodiments, if the user 101 of the purchase prediction system 107 is a retailer, then the one or more purchase recommendations 108 generated by the purchase recommendation module 221 may include information on appropriate products that may be sold to the user 101. Using such recommendations, the retailers may also determine a right value or price in which the one or more products must be sold to the user 101.

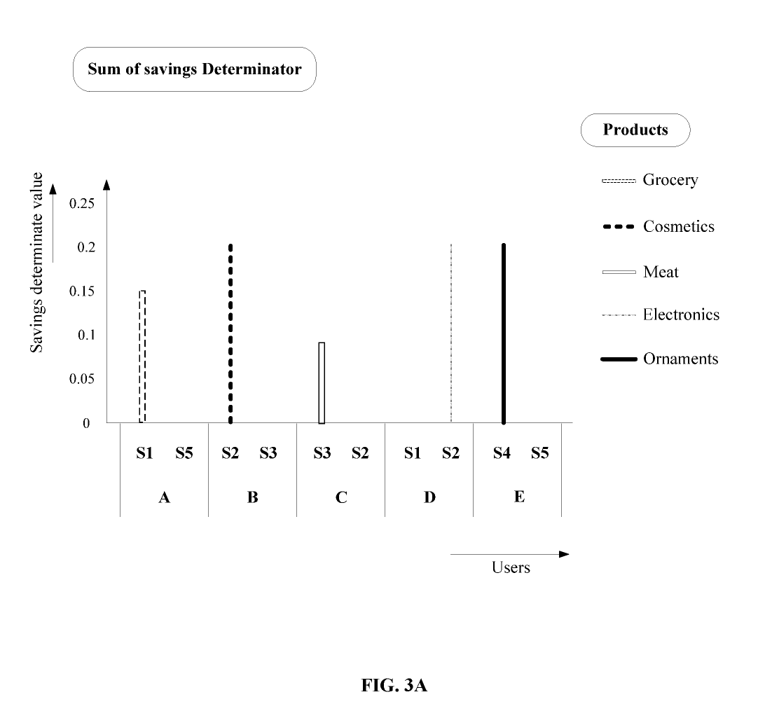

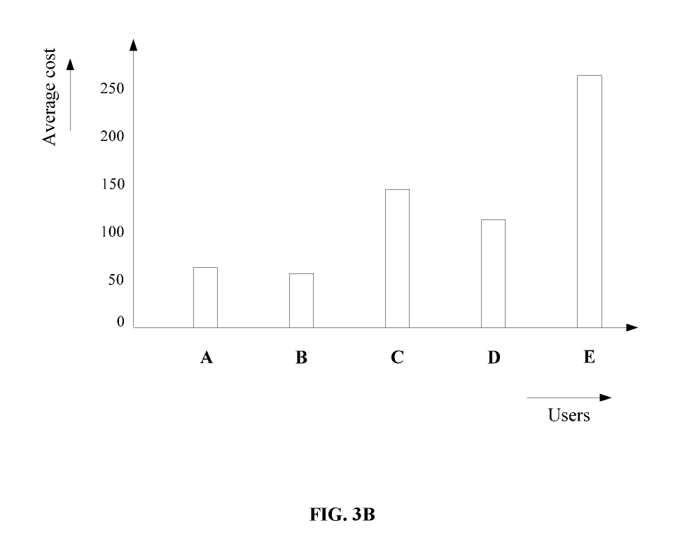

FIG. 3A and FIG. 3B represent exemplary outcomes of an analysis of purchase pattern of the user 101 in accordance with an exemplary embodiment of the present disclosure.

Consider a customer database system which has the details of one or more users (customers), as shown in Table A below. In an embodiment, the customer database system may include user information 106 such as, without limiting to, name of the user, location of the user and date of birth of the user. Since age of the user is one among the plurality of optimal purchase parameters 211, the purchase prediction system 107, uses one or more predetermined artificial intelligence techniques to calculate the present age of the user based on the date of birth of the user as shown in Table A.

TABLE A

| Name of User | Location | Date of Birth | Age |
|---|---|---|---|
| A | L1 | Jan. 1, 1992 | 25 |
| B | L2 | Feb. 1, 1973 | 44 |
| C | L3 | Mar. 1, 1984 | 33 |
| D | L1 | Apr. 1, 1955 | 62 |
| E | L4 | May 1, 1966 | 51 |
| F | L3 | Jun. 1, 1979 | 38 |

Here, age of the user acts as a major driving factor on purchases and shopping. As an example, a person aged more than 40 years may be mostly interested in shopping on groceries, child care products and medication. On the other hand, a person who is aged less than 40 years would be more interested in cosmetics, clothing, fashion and the like. In an embodiment, if the age of the user is not known, then the purchase prediction system 107 would analyze the one or more activities of the user to accurately map the details of the user with the required prediction logic.

In an embodiment, the number of visits by the user into one or more retail stores and the frequency of visits may be considered as an important factor for determining the purchasing trend of the user. As an example, the number of visits and the frequency of visits by the one or more users (A-F) for purchasing the one or more products (P1-P4) from the one or more retail stores (S1-S4) at location (L1-L4) may be as indicated below in Table B.

TABLE B

| Name | | | Visit | Weekly | Yearly | | | |
|---|---|---|---|---|---|---|---|---|
| of | Loca- | | Num- | average | average | | Retail | Average |
| User | tion | Age | ber | visits | visits | Product | store | cost |
| A | L1 | 25 | 5 | 1 | 1 | P1 | S1 | Rs. 20 |
| B | L2 | 44 | 3 | 0.5 | 0.2 | P2 | S2 | Rs. 25 |
| C | L3 | 33 | 5 | 0.2 | 0.2 | P3 | S3 | Rs. 55 |
| D | L1 | 62 | 6 | 3 | 3 | P1 | S1 | Rs. 33 |
| E | L4 | 51 | 7 | 1 | 1 | P4 | S4 | Rs. 77 |
| F | L3 | 38 | 8 | 5 | 5 | P3 | S3 | Rs. 34 |

As an example, if a person ‘A’ has visited one of the one or more retails stores 5 times in a week, then the weekly average values of the number of visits would be 1 and yearly average values of the number of visits would be 1. In an embodiment, the purchase prediction system 107 may collect details related to the location of the various retail shops that the user has visited over a period. The location details of the one or more retails shops visited by the user would help in understanding the purchase trend of the user. Collecting and analyzing the location details would also help to avoid data replication, since the segregation of data removes multiple entries of the same data. Further, based on the location details, the purchase prediction system 107 identifies an association between the user and the one or more retail stores.

For example, if the user ‘A’ always prefers to purchase a product P1′ from a retail store ‘S1’, then the association between the user ‘A’ and the retail store ‘S1’ would be maximum. Hence, the user ‘A’ must be able to purchase the product P1′ from the retail store ‘S1’ at an optimal rate of savings. Further, if a retail store ‘S2’ offers to sell the same product P1′ at a much higher savings rate, then the purchase prediction system 107 would recommend the user to purchase P1′ from the retailer ‘S2’.

In an embodiment, upon determining the association between the user and the one or more retail stores, the purchase prediction system 107 may evaluate a purchase determinate value associated with the user. As an example, the purchase determinate value of the user may be the number of times that the user has visited the one of the one or more retail stores for purchasing a single product, ‘P’. Table C indicates exemplary purchase determinate value of the one or more users (A-E).

TABLE C

| | | | Weekly | Yearly | | Purchase |
|---|---|---|---|---|---|---|
| Name | | Visit | average | average | Retail | Determinate |
| of User | Product | Number | visits | visits | store | value |
| A | Grocery | 5 | 1 | 1 | S1 | 6 |
| B | Cosmetics | 3 | 0.5 | 0.2 | S2 | 1.7 |
| C | Meat | 8 | 5 | 5 | S3 | 45 |
| D | Pharmacy | 6 | 3 | 3 | S1 | 21 |
| E | Ornaments | 7 | 1 | 1 | S4 | 8 |
| A | Toiletries | 5 | 1 | 1 | S5 | 6 |
| B | Pets | 0 | 0.5 | 0.2 | S3 | 0.2 |
| C | Shoes | 5 | 0.2 | 0.2 | S2 | 1.2 |
| D | Electronics | 5 | 1 | 1 | S7 | 6 |
| E | Plants | 2 | 0.1 | 0.1 | S5 | 0.3 |

Further, the purchase prediction system 107 may identify a savings determinate value for each of the users based on individual discounts/savings offered at the one or more retails stores in which the one or more users have purchased the one or more products previously. As an example, the savings determinate value for a user may be picked as the highest savings rate that the user can get while purchasing one of the one or more product from one or more retail stores. The savings determinate values for the one or more users (A-E) is indicated in Table D below.

TABLE D

| | | | | Savings offered at | | | | |
|---|---|---|---|---|---|---|---|---|
| | | | Purchase | retail stores (in %) | | | | Savings |
| | | Retail | Determinate | | | | Medical | Determinate |
| Name of User | Product | store | value | S1 | S2 | S3 | store | value (in %) |
| A | Grocery | S1 | 6 | 5 | 0 | 15 | | 15 |
| B | Cosmetics | S2 | 1.7 | 0 | 0 | 20 | | 20 |
| C | Meat | S3 | 45 | 9 | 10 | 0 | | 9 |
| D | Pharmacy | S1 | 21 | 0 | 0 | 0 | 12 | 12 |
| E | Ornaments | S4 | 8 | 0 | 0 | 20 | | 20 |
| A | Toiletries | S5 | 6 | 0 | 5 | 0 | | 5 |
| B | Pets | S3 | 0.2 | 4 | 0 | 0 | | 4 |
| C | Shoes | S2 | 1.2 | 0 | 0 | 0 | | 0 |
| D | Electronics | S2 | 6 | 0 | 20 | 0 | | 20 |
| E | Plants | S5 | 0.3 | 8 | 0 | 0 | | 8 |

As indicated in Table D, the savings determinate value for a user ‘A’ may be determined by identifying the one or more retail stores that offer a savings to the user ‘A’ and then identifying one of the one or more retail stores that offer a maximum savings to the user ‘A’. In the above example, the retail shops ‘S1’ and S3′ offer a savings of ‘5%’ and ‘15%’ respectively for the user ‘A’, when the user ‘A’ is willing to purchase ‘Grocery’ products. Here, based on the analysis of the savings rate, the purchase prediction system 107 may recommend the user ‘A’ to visit the retail store S3′, since the savings for the user ‘A’ would be higher at the retail store S3′, which is 15%.

Similarly, consider the user ‘D’, who is a frequent purchaser of ‘Pharmacy’ products. Here, the purchase prediction system 107 would understand that the user ‘D’ is a frequent purchaser of the ‘Pharmacy’ products, since the purchase determinate value associated with the user ‘D’ with respect to ‘Pharmacy’ products is high, i.e. 21. Also, the purchase prediction system 107 may analyze the age of the user ‘D’ (62 years), and determine that the user ‘D’ is most likely to purchase health related products. Accordingly, the purchase prediction system 107 may identify a medical store that offers a maximum discount on the purchase of ‘Pharmacy’ products, and recommends the user ‘D’ to visit the identified medical store for purchasing the required ‘Pharmacy’ products. Further, the purchase prediction system 107 may consider the location details of the user to identify the medical store that offers the maximum discount and is in the nearest locality of the user ‘D’.

Further, consider the user ‘C’, who is willing to purchase ‘Meat’ and ‘Shoes’. Here, the purchase determinate value for the user ‘C’, corresponding to the products ‘Meat’ and ‘Shoes’ is ‘1.2’ and ‘45’ respectively. Based on the analysis of the purchase determinate values of the user ‘C’, the purchase prediction system 107 identifies that the user ‘C’ is a frequent buyer of ‘Meat’. Hence, the purchase prediction system 107 identifies the one or more retail stores that offer to sell meat at a higher rate of discount to the user ‘C’. For example, let the retail stores ‘S1’ and ‘S3’ offer a discount of ‘9%’ and ‘10%’ respectively on the purchase of meat. For example, say, the user ratings and reviews for the retail store ‘S2’ is not favorable when compared to that of the retail store ‘S1’, which is well-known to sell fresh meat. In such scenarios, the purchase prediction system 107 may apply the preconfigured artificial intelligence techniques in the analysis for determining that the retail store ‘S1’ must be recommended for the user ‘C’, even though the discount offered by the retail store ‘S2’ is higher than the retail store ‘S1’, due to the reason that the quality of meat sold at ‘S1’ is better than ‘S2’.

On the other hand, the one or more retailers of the one or more retail stores may use the above analysis of the one or more users to identify what products must be sold to which user and at what price should the one or more products be sold to the one or more users. Accordingly, the purchase prediction system 107 may further analyze the purchase trend of the one or more users to predict the number of visits by the one or more users and need of the one or more products to the one or more users in future. Also, the purchase prediction system 107 would recommend the retailers on the appropriate rate of discount that must be provided on the one or more products for increasing the chances of the one or more users purchasing the one or more products from the retailers.

In an embodiment, the purchase prediction system 107 may assign a weightage score to one or more purchase parameters for predicting the future purchases by the one or more users. As an example, the purchase prediction system 107 may assign a relative weightage score to each of the one or more purchase parameters such as, average spending by the user, number of visits by the user, frequency of visits by the user, the purchase determinate values associated with the user and the savings determinate values corresponding to the user for predicting the future purchases of the user. Table E below indicates weightage scores assigned to each of the one or more purchase parameters for each of the one or more users.

TABLE E

| | | | | | | | Predicted values | | | |
|---|---|---|---|---|---|---|---|---|---|---|
| | | | | | | | | | Savings | |
| | | Visit | Avg. visits | | | Avg. | | | determinate | Expense |
| User | Product | Num. | Week | Year | Store | spending | Visits | Need | value | value |
| A | Grocery | 5 | 1 | 1 | S1 | Rs. 20 | 10 | 40 | 15 | 38.5 |
| B | Cosmetics | 3 | 0.5 | 0.2 | S2 | Rs. 25 | 6 | 30 | 20 | 28.8 |
| C | Meat | 8 | 5 | 5 | S3 | Rs. 34 | 16 | 108.8 | 10 | 107.2 |
| D | Pharmacy | 6 | 3 | 3 | S1 | Rs. 33 | 12 | 79.2 | 10 | 78 |
| E | Ornament | 7 | 1 | 1 | S4 | Rs. 77 | 14 | 215.6 | 5 | 214.9 |
| A | Toiletries | 5 | 1 | 1 | S5 | Rs. 20 | 10 | 40 | 0 | 40 |
| B | Pets | 0 | 0.5 | 0.2 | S3 | Rs. 25 | 0 | 0 | 0 | 0 |
| C | Shoes | 5 | 0.2 | 0.2 | S2 | Rs. 55 | 10 | 110 | 0 | 110 |
| D | Electronic | 5 | 1 | 1 | S7 | Rs. 20 | 10 | 40 | 15 | 38.5 |
| E | Plants | 2 | 0.1 | 0.1 | S5 | Rs. 77 | 4 | 61.6 | 5 | 61.4 |

As an example, the number of visits may be predicted by doubling the number of previous visits by the one or more users. i.e., if the user ‘A’ has visited the retail store in 5 previous occasions, then the predicted number of visits by the user ‘A’ is calculated to be 10.

Further, in an embodiment, need of the one or more users for purchasing the one or more products may be determined based on the average spending of the user and the predicted number of visits by the one or more users. For example, need of the one or more users may be calculated using equation (1) below:

Need of the user=(Average spending by the user/5)*Predicted number of visits by the use (1)

In an embodiment, the savings determinate value for the one or more users across the one or more retail stores may be collected in real-time from the retailers of the one or more retail stores. The savings determinate values across the one or more retail stores are dynamically set by the retailers of the one or more retail stores based on the current trends in market and the one or more retail stores.

Furthermore, the expense value for the one or more users may be predicted based on the need of the or more users, savings determinate value across the one or more retail stores and the predicted number of visits by the one or more users. For example, the expense value for the one or more users may be calculated using equation (2) below:

Expense value=(Need of the user)−[(savings determinate value/100)*(Predicted number of visits) (2)

Finally, the purchase prediction system 107 may generate one or more analysis reports based on the prediction of the future purchasing trends of the one or more users. In an embodiment, the generated analysis reports may be provided to the one or more users and the retailers, using which the one or more users and the retailers may understand the current and predicted trends in purchasing. For example, the FIG. 3A indicates the savings determinate value of the one or more users across the one or more retail stores visited by the user. FIG. 3B indicates the average spending of the one or more users for purchasing the one or more products from the one or more retail stores.

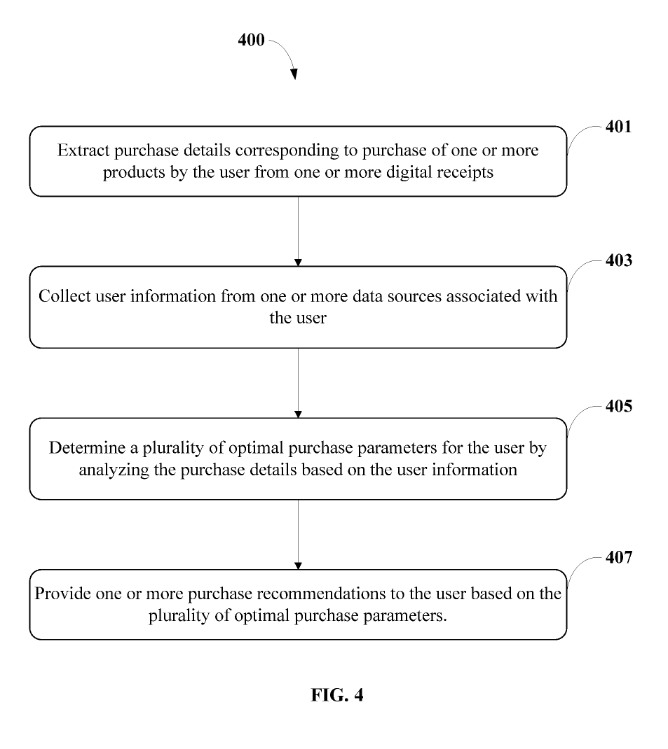

FIG. 4 shows a flowchart illustrating a method of providing one or more purchase recommendation to the user in accordance with some embodiments of the present disclosure.

As illustrated in FIG. 4, the method 400 includes one or more blocks for providing one or more purchase recommendations 108 to the user, using a purchase prediction system 107. The method 400 may be described in the general context of computer executable instructions. Generally, computer executable instructions can include routines, programs, objects, components, data structures, procedures, modules, and functions, which perform specific functions or implement abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the method 400 includes extracting, by the purchase prediction system 107, purchase details 104 corresponding to purchase of one or more products by the user from one or more digital receipts 103. As an example, the purchase details 104 may include, without limiting to, at least one of name of the user, name of the one or more products purchased by the user, purchase value of the one or more products and details of the one or more retail stores including the one or more products purchased by the user.

At block 403, the method 400 includes collecting, by the purchase prediction system 107, user information 106 from one or more data sources 105 associated with the user. As an example, the user information 106 may include, without limiting to, at least one of name of the user, age of the user, location details of the user, details of one or more previous purchases by the user, number of visits by the user to the one or more retail stores and weekly average values of the number of visits and yearly average values of the number of visits.

At block 405, the method 400 includes determining, by the purchase prediction system 107, a plurality of optimal purchase parameters 211 for the user by analyzing the purchase details 104 based on the user information 106. As an example, the plurality of optimal purchase parameters 211 may include, without limiting to, age of the user, location details of the user and current trends in one or more retail stores. In an embodiment, the method 400 may further include classifying the purchase details 104 prior to determining the plurality of optimal purchase parameters 211.

At block 407, the method 400 includes providing, by the purchase prediction system 107, one or more purchase recommendations 108 to the user based on the plurality of optimal purchase parameters 211. As an example, the one or more purchase recommendations 108 may include, without limiting to, details of one or more retail stores for purchasing the one or more products in an optimal savings rate.

Further, providing the one or more purchase recommendations 108 includes identifying one or more procurement factors based on at least one of the plurality of optimal purchase parameters 211. In an embodiment, the one or more procurement factors may be identified based on significance of purchase to the user if the age of the user is higher than a predetermined threshold value. In another embodiment, the one or more procurement factors may be identified based on frequency of purchase by the user if the age of the user is less than or equal to the predetermined threshold value.

### Computer System

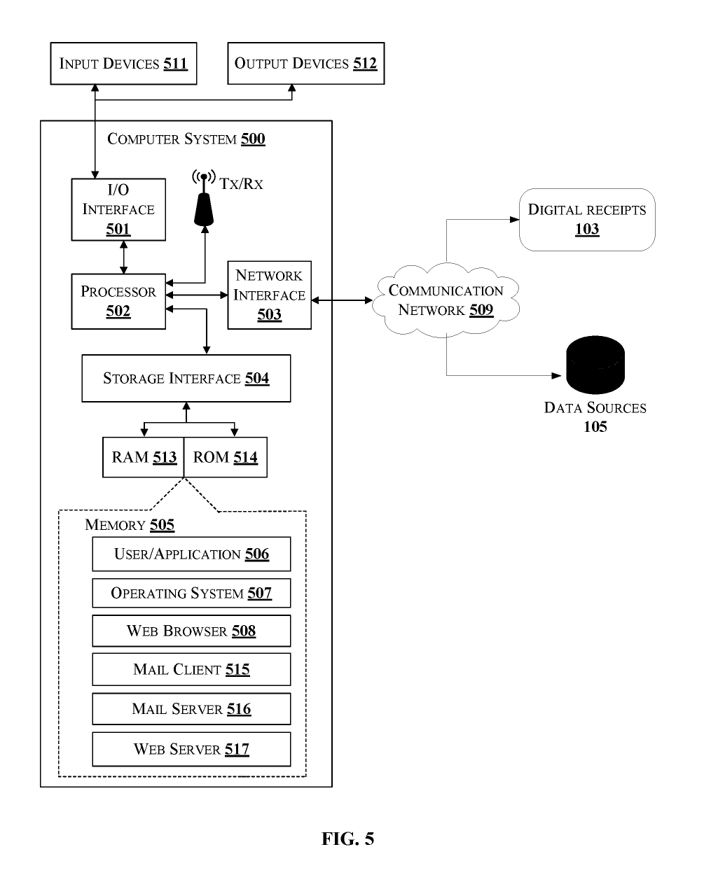

FIG. 5 illustrates a block diagram of an exemplary computer system 500 for implementing embodiments consistent with the present disclosure. In an embodiment, the computer system 500 may be the purchase prediction system 107 which may be used for providing one or more purchase recommendations 108 to the user. The computer system 500 may include a central processing unit (“CPU” or “processor”) 502. The processor 502 may include at least one data processor for executing program components for executing user- or system-generated business processes. A user may include a person, a customer, a person using a device such as those included in this invention, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 501, the computer system 500 may communicate with one or more I/O devices (511 and 512). In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

Using the network interface 503 and the communication network 509, the computer system 500 may access the one or more data sources 105 for collecting user information 106 related to the user. Further, the communication network 509 may be used to receive purchase details 104 corresponding to purchase of one or more products by the user, which are extracted from the digital receipts 103. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application data 506, an operating system 507, web server 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server stored program component. The mail server 516 may be an Internet mail server such as Microsoft Exchange, or the like. The mail server 516 may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client 515 stored program component. The mail client 515 may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Examples of Advantages of the Embodiment of the Present Disclosure are Illustrated Herein

In an embodiment, the method of present disclosure provides one or more purchase recommendations to the user based on details of previous purchases by the user and current trends in the retail stores.

In an embodiment, the method of present disclosure helps retailers to analyze the purchase pattern of the users for predicting and determining appropriate products to be sold to the user in during their future purchases.

In an embodiment, the method of present disclosure facilitates the users to identify a retail store that offers optimal savings on purchase of a product by the user.

In an embodiment, the present disclosure discloses a method for classifying and sorting one or more digital receipts associated with the user, thereby facilitating the users to effectively keep a track of all the digital receipts.

In an embodiment, the method of present disclosure provides greater visibility to the users to understand current trends across the retail stores based on digital receipts associated with the user.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of providing one or more purchase recommendations to a user, the method comprising:
extracting, by a purchase prediction system, purchase details corresponding to purchase of one or more products by the user from one or more digital receipts;
collecting, by the purchase prediction system, user information from one or more data sources associated with the user;
determining, by the purchase prediction system, a plurality of optimal purchase parameters for the user by analyzing the purchase details based on the user information, wherein the plurality of optimal purchase parameters comprises age of the user, location details of the user and current trends in one or more retail stores; and
providing, by the purchase prediction system, one or more purchase recommendations to the user based on the plurality of optimal purchase parameters.

2. The method as claimed in claim 1, wherein the purchase details comprises at least one of name of the user, name of the one or more products purchased by the user, purchase value of the one or more products and details of the one or more retail stores comprising the one or more products purchased by the user.

3. The method as claimed in claim 1, wherein the user information comprises at least one of name of the user, age of the user, location details of the user, details of one or more previous purchases by the user, number of visits by the user to the one or more retail stores, weekly average values of the number of visits and yearly average values of the number of visits.

4. The method as claimed in claim 1 and further comprising classifying the purchase details prior to determining the plurality of optimal purchase parameters.

5. The method as claimed in claim 1, wherein providing the one or more purchase recommendations comprises identifying one or more procurement factors based on at least one of the plurality of optimal purchase parameters.

6. The method as claimed in claim 5, wherein the one or more procurement factors are identified based on:
significance of purchase to the user when the age of the user is higher than a predetermined threshold value; or
frequency of purchase by the user when the age of the user is less than or equal to the predetermined threshold value.

7. The method as claimed in claim 1, wherein the one or more purchase recommendations comprises details of one or more retail stores for purchasing the one or more products in an optimal savings rate.

8. A purchase prediction system for providing one or more purchase recommendations to a user, the purchase prediction system comprises:
a processor; and
a memory, communicatively coupled to the processor, wherein the memory stores processor-executable instructions, which, on execution, causes the processor to:
extract purchase details corresponding to purchase of one or more products by the user from one or more digital receipts;
collect user information from one or more data sources associated with the user;
determine a plurality of optimal purchase parameters for the user by analyzing the purchase details based on the user information, wherein the plurality of optimal purchase parameters comprises age of the user, location details of the user and current trends in one or more retail stores; and
provide one or more purchase recommendations to the user based on the plurality of optimal purchase parameters.

9. The purchase prediction system as claimed in claim 8, wherein the purchase details comprises at least one of name of the user, name of the one or more products purchased by the user, purchase value of the one or more products and details of the one or more retail stores comprising the one or more products purchased by the user.

10. The purchase prediction system as claimed in claim 8, wherein the user information comprises at least one of name of the user, age of the user, location details of the user, details of one or more previous purchases by the user, number of visits by the user to the one or more retail stores and weekly average values of the number of visits and yearly average values of the number of visits.

11. The purchase prediction system as claimed in claim 8, wherein the instructions further cause the processor to classify the purchase details prior to determining the plurality of optimal purchase parameters.

12. The purchase prediction system as claimed in claim 8, wherein the processor identifies one or more procurement factors based on at least one of the plurality of optimal purchase parameters to provide the one or more purchase recommendations.

13. The purchase prediction system as claimed in claim 12, wherein the processor identifies the one or more procurement factors based on:
significance of purchase to the user when the age of the user is higher than a predetermined threshold value; or
frequency of purchase by the user when the age of the user is less than or equal to the predetermined threshold value.

14. The purchase prediction system as claimed in claim 8, wherein the one or more purchase recommendations comprises details of one or more retail stores to purchase the one or more products in an optimal savings rate.
